(19) United States
(12) Patent Application Publication
(10) Pub. No.: US 2023/0194664 A1
(43) Pub. Date: Jun. 22, 2023

(54) METHOD FOR TRAINING A RADAR-BASED OBJECT DETECTION AND METHOD FOR RADAR-BASED SURROUNDINGS DETECTION

(71) Applicant: Robert Bosch GmbH, Stuttgart (DE)

(72) Inventors: Tobias Strauss, Obersulm (DE); Ali Alawieh, Untergruppenbach (DE)

(21) Appl. No.: 18/064,428

(22) Filed: Dec. 12, 2022

(30) Foreign Application Priority Data
Dec. 21, 2021 (DE) 10 2021 214 760.7

(51) Int. Cl. G01S 7/41; G01S 7/35; G01S 13/89

(52) U.S. Cl. CPC G01S 7/412; G01S 7/417; G01S 7/356; G01S 13/89

(57) ABSTRACT

A method for training a radar-based object detection. The method includes: creating a training data set that includes radar data of a radar sensor or of a plurality of radar sensors, the radar data representing a map of surroundings of the radar sensor or of the plurality of radar sensors; training a radar-based object detection based on the created training data set for generating an output representation of the surroundings of the radar sensor.

### CROSS REFERENCE

The present application claims the benefit under 35 U.S.C. § 119 of German Patent Application No. DE 10 2021 214 760.7 filed on Dec. 21, 2021, which is expressly incorporated herein by reference in its entirety.

### FIELD

The present invention relates to a method for training a radar-based object detection. The present invention further relates to a method for radar-based surroundings detection.

### BACKGROUND INFORMATION

Driver assistance systems and automated driving require an efficient and robust surroundings detection. Radar sensors, among others things, are used for detecting the stationary and dynamic vehicle surroundings. These emit appropriately modulated radar signals via one or multiple antennas. The signals reflected by the surroundings are subsequently detected again by one or by multiple receiving antennas and demodulated with the transmit signal. The result is time signals, which are digitally sampled and further processed. The aim of the radar data processing is to obtain pieces of information from the time signals about the objects present—in particular their position and relative velocity, but also about further attributes such as, for example, the backscatter cross section (BCS). For localizing the vehicle in conjunction with automated driving, clusters (radar road signature) are formed from the static point targets. One possible alternative for representing surroundings is represented, for example, by reflectance grids, as they are also widely common for other sensor modalities (for example, camera, LIDAR). The conventional systems for radar-based surroundings detection require a substantial signal processing in order to obtain meaningful pieces of information from the time signals relating to possible objects situated in the surroundings of the sensors.

### SUMMARY

It is an object of the present invention to provide an improved method for training a radar-based object detection and an improved method for radar-based surroundings detection.

This object is achieved by the method for training a radar-based object detection and by the method for radar-based surroundings detection according to the present invention. Advantageous embodiments of the present invention are disclosed herein.

According to one aspect of the present invention, a method is provided for training a radar-based object detection. According to an example embodiment of the present invention, the method includes:

creating a training data set that includes radar data of a radar sensor or of a plurality of radar sensors, the radar data representing a map of surroundings of the radar sensor or of the plurality of radar sensors;
training a radar-based object detection based on the created training data set for generating an output representation of the surroundings of the radar sensor, the output representation being formed as a point cloud of reflectance points of radar signals or as a point cluster or as a plurality of point clusters of a radar road signature map display or as a reflectance grid, the reflectance grid describing a grid-like representation of the surroundings of the radar sensor or of the plurality of radar sensors, and each grid cell of the reflectance grid being provided with a reflectance value, with the aid of which a backscatter characteristic of radar signals of the respective spatial area is described.

This may yield the technical advantage that an improved method for training a radar-based object detection may be provided. Thus, a training data set of radar data of one or of a plurality of radar sensors is initially created, the radar data representing in each case a map of surroundings of the radar sensor or of the plurality of radar sensors. A corresponding radar-based object detection based on the created training data is subsequently trained to generate an output representation of the surroundings of the radar sensor based on the radar data of the training data set. The output representation in this case represents a one-dimensional, two-dimensional or three-dimensional representation of the surroundings of the radar sensor. The output representation may, for example, be designed as a point cloud of reflectance points of radar signals of the radar sensor. The reflectance points in this case describe a location representation of points within the surroundings of the radar sensor at which reflections of the radar signals of the radar sensor have taken place. The reflectance points in this case may include pieces of location information, information relating to relative speeds of the respective object causing the reflections to the radar sensor and a backscatter characteristic of the reflectance values describing the object. The output representation may alternatively be designed as a point cluster or as a plurality of point clusters of a radar road signature map display (radar road signature). The point clusters in this case may include location information, information relating to relative speeds of the respective object causing the reflections to the radar sensor and reflectance values describing a backscatter characteristic of the object. Alternatively, the output representation may be designed as a reflectance grid. The reflectance grid in this case may represent a grid-like representation of the surroundings of the radar sensors represented by the radar data. The radar-based object detection in this case is trained to assign reflectance values to the grid cells of the reflectance grid, each of which describes a backscatter characteristic with respect to radar signals of the spatial area, represented in each case by the grid cells, of the surroundings of the radar sensors represented by the radar data. In addition to the reflectance values, the grid cells may also include information relating to relative speeds of dynamic objects, which move within the surroundings relative to the radar sensor. The radar-based object detection trained in this way is therefore configured to generate a reflectance grid of the surroundings represented by the radar data based on radar data of one or of a plurality of radar sensors. A radar-based object detection of this type may be carried out after successful training in a radar-based surroundings detection, for example, in a vehicle equipped with radar sensors.

According to an example embodiment of the present invention, the radar-based object recognition is designed as an artificial intelligence. By applying the radar-based object detection designed as artificial intelligence, it is thus possible to achieve an improved surroundings detection, a lengthy and computer-intensive signal processing of the radar data of the radar sensors for generating corresponding output representations, for example, in the form of reflectance grids, being capable of being avoided due to the corresponding training of the radar-based object detection.

According to one specific embodiment of the present invention, the radar data are raw data of FMCW radar sensors and are designed as time signals.

This may yield the technical advantage that the radar-based object detection may be directly trained for the raw data of the radar sensors designed as FMCW radar sensors and the trained radar-based object detection may be applied to corresponding raw data. Raw data of the FMCW radar sensors are designed as time signals within the context of the application and are based on interferences between a reference signal of an FMCW radar sensor and radar signals of the FMCW radar sensor received by the radar sensor. The radar signals of the FMCW radar sensor as well as the reference signal are frequency-modulated in this case. By using the raw data of the FMCW radar sensors, it is possible to achieve a reduction of the required signal processing of the radar data. Moreover, by applying the radar-based object detection to the raw data, a loss of information may be avoided, which would inevitably occur in an implemented signal processing of the raw data of the FMCW radar sensors. Furthermore, a uniformity of the input data of the radar-based object detection may be achieved by using the raw data for training the radar-based object recognition or as input data of the trained radar-based object detection. The raw data of the FMCW radar sensors are based in this case on a predetermined number of sampling points of the interference signal of the radar sensor based on the interference between the reference signal and the received signals. Via the predetermined number of sampling points, it is thus possible to achieve a data format of the input data of the radar-based object detection. An application of a radar-based object detection, designed, for example, as a neural network, to the raw data designed in this way with a uniform data format is thus made possible.

According to one specific embodiment of the present invention, the radar data are based on an execution of a two-dimensional fast Fourier transform on the raw data and are designed as frequency signals.

This may yield the technical advantage that a simplification of the training of the radar-based object detection is made possible. As a result of the implemented pre-processing of the raw data in the form of an execution of a two-dimensional fast Fourier transform and the generation of frequency signals based thereon, it is possible to reduce an information content of the raw data to a portion essential for the object detection. As a result of the pre-processing and the generation of the frequency signals, it is possible to isolate frequencies, in particular, the beat frequencies, within the time signals of the raw data. Based on the isolated frequencies of the frequency signals, it is possible to ascertain distances or relative movements of objects relative to the radar sensor in a simplified manner. In this way, the training of the radar-based object detection and the assignment between the input data designed as frequency signals and the output data of the radar-based object detection designed as an output representation, for example, in the form of a reflectance grid, may be simplified as a representation of the surroundings of the radar sensors represented by the input data.

According to one specific embodiment of the present invention, the training data set is based on radar data based on measurements of the radar sensor or of the plurality of radar sensors and/or on radar data based on simulations of radar measurements.

This may achieve the technical advantage that a simplified creation of the training data set and a more comprehensive training data set is made possible. For this purpose, radar data, which are based on actual measurements of radar sensors, or which have been generated by corresponding simulations of equivalent radar measurements, may be taken into account in the training data set. By taking radar data into account that are based on corresponding simulations of radar measurements, it is possible to arbitrarily increase a scope of the training data set—without great effort and without complex radar measurements having to be carried out for this purpose. As a result of the correspondingly comprehensive training data set, it is possible to further improve the training of the radar-based object detection. By taking radar data based on actual measurements and radar data based on simulations into account, a high diversity of the training data set may be achieved, which also contributes to the improvement of the training of the radar-based object detection.

According to one specific embodiment of the present invention, sensor calibrations of the radar sensors in the form of correlations between radar signals reflected at point targets situated in the surroundings and corresponding time signals of the radar sensors are taken into account in the simulations.

This may yield the technical advantage that a precise simulation of the radar measurements and, associated therewith, a precise simulation of actual radar data may be achieved. As a result of the improved simulation, it is possible to achieve an improved training data set and, associated therewith, an improved training of the radar-based object detection.

According to one specific embodiment of the present invention, interference disruptions of various radar signals are taken into account in the simulations.

This may achieve the technical advantage that a further improvement of the simulation and of the correspondingly simulated radar data is achieved by taking interference disruptions of various radar signals of different radar sensors into account. The radar data originating from the simulation may thus be further adapted to radar data of actual radar measurements.

According to one specific embodiment of the present invention, the training data further include pieces of calibration information relating to the sensor calibration of the radar sensors, the pieces of calibration information being utilized as input data of the object detection.

This may achieve the technical advantage that the training data set may be further improved. For this purpose, the pieces of calibration information with respect to those for the calibration are inserted as independent information into the training data set and are used for the training as input data of the radar-based object detection. Using the additional information, it is possible to achieve a more precise training of the radar-based object detection and, associated therewith, an improvement of the performance of the trained radar-based object detection.

According to one specific embodiment of the present invention, the object detection is designed as a neural network.

This may achieve the technical advantage that an efficient radar-based object detection may be provided.

According to one specific embodiment of the present invention, the neural network is designed with a recurrent network structure and is trained to filter out a filtering of influences of objects dynamically moved relative to the radar sensor or to the plurality of radar sensors.

This may achieve the technical advantage that measuring inaccuracies of the radar data may be further reduced and a better training of the radar-based object detection and a better performance of the trained radar-based object detection may be achieved as a result. Signals of objects moved relative to the respective radar sensors may result in incorrect measurements and in faulty interpretations, in particular, with respect to the distance or position of objects relative to the radar sensor. The filtering of such influences via the radar-based object detection may result in a more precise output representation of the surroundings, for example, in the form of a reflectance grid. According to the present invention, only static objects are taken into account in the reflectance grid generated by the radar-based object detection. Alternatively, however, dynamic objects in the form of pieces of speed information may also be taken into account.

According to one further aspect of the present invention, a method for radar-based surroundings detection is provided. According to an example embodiment of the present invention, the method includes:

receiving radar data of a radar sensor or of a plurality of radar sensors, the radar data mapping the surroundings of the radar sensor or of the plurality of radar sensors;
carrying out an object detection on the received radar data, the object detection being trained according to the method for training a radar-based object detection according to one of the preceding specific embodiments;
and
outputting an output representation of the surroundings of the radar sensor by the object detection, the output representation being designed as a point cloud of reflectance points of radar signals or as a point cluster or as a plurality of point clusters of a radar road signature map display or as a reflectance grid, the reflectance grid representing a grid-like representation of the surroundings of the radar sensor or of the plurality of radar sensors, and each grid cell of the reflectance grid being provided with a reflectance value, with the aid of which a backscatter characteristic of radar signals of the respective spatial area is described.

This may achieve the technical advantage that an improved method for radar-based surroundings detection may be provided. According to the present invention, a radar-based object detection based on an artificial intelligence, which is trained according to the method according to the present invention for training a radar-based object detection, is applied for this purpose to radar data of a radar sensor or of a plurality of radar sensors. The correspondingly trained radar-based object detection in this case is configured to output an output representation of the surroundings of the radar sensor based on the radar data. The output representation in this case may be designed as a point cluster of reflectance points of radar signals or as a point cluster or as a plurality of point clusters of a radar road signature map display or as a reflectance grid. A point cloud of reflectance points in this case describes a location representation of points within the surroundings, at which a reflection of the radar signals of the radar sensor has taken place. The reflectance points may further include information relating to relative speeds of an object causing the reflection to the radar sensor and reflectance values describing a backscatter characteristic of the object. In addition to pieces of location information, the point clusters may also include speed information and reflectance values. A reflectance grid in this case describes an at least two-dimensional representation as a representation of the surroundings of the radar sensors mapped by the radar data. By using an artificial intelligence as a radar-based object detection, an improved and simplified surroundings detection may take place since, as a result of the correspondingly trained radar-based object detection, a lengthy and computationally intensive signal processing of the radar data of the radar sensors for generating an output representation, for example, in the form of a reflectance grid, may be avoided. The implementation of a radar-based object detection correspondingly trained and designed as artificial intelligence takes place in this case rapidly and precisely, so that a reliable and robust surroundings detection based on radar data of a plurality of radar sensors is able to be provided. When designing the output representation in the form of a reflectance grid, in which grid cells are assigned corresponding reflectance values, by which backscatter characteristics for radar signals of the spatial area of the surroundings represented in each case by the grid cells are described, a precise reproduction of the surroundings of the radar sensors may be provided by the reflectance grid. In addition to the reflectance values, the grid cells may include information relating to relative speeds of dynamic objects within the surroundings of the radar sensors. The correspondingly output reflectance grid may further be continued to be used for an object recognition of the objects positioned in the surroundings of the radar sensors.

According to one specific embodiment of the present invention, the radar data are based on an execution of a two-dimensional fast Fourier transform on the raw data and are designed as frequency signals.

This may yield the technical advantage of an improved surroundings detection for a vehicle.

According to one further aspect of the present invention, a processing unit is provided, which is configured to carry out the method for training a radar-based object detection according to one of the preceding specific embodiments and/or the method for radar-based surroundings detection according to one of the above-described specific embodiments.

According to one further aspect of the present invention, a computer program product is provided including commands which, when the program is executed by a data processing unit, prompt the data processing unit to carry out the method for training a radar-based object detection according to one of the preceding specific embodiments and/or the method for radar-based surroundings detection according to one of the preceding specific embodiments.

### BRIEF DESCRIPTION OF THE DRAWINGS

Exemplary embodiments of the present invention are explained based on the following figures.

FIG. 1 schematically shows a representation of a system for training a radar-based object detection and for carrying out a radar-based surroundings detection, according to an example embodiment of the present invention.

FIG. 2 shows a flowchart of the method for training a radar-based object detection, according to an example embodiment of the present invention.

FIG. 3 shows a flowchart of the method for radar-based surroundings detection, according to an example embodiment of the present invention.

FIG. 4 schematically shows a representation of a computer program product, according to an example embodiment of the present invention.

### DETAILED DESCRIPTION OF EXAMPLE EMBODIMENTS

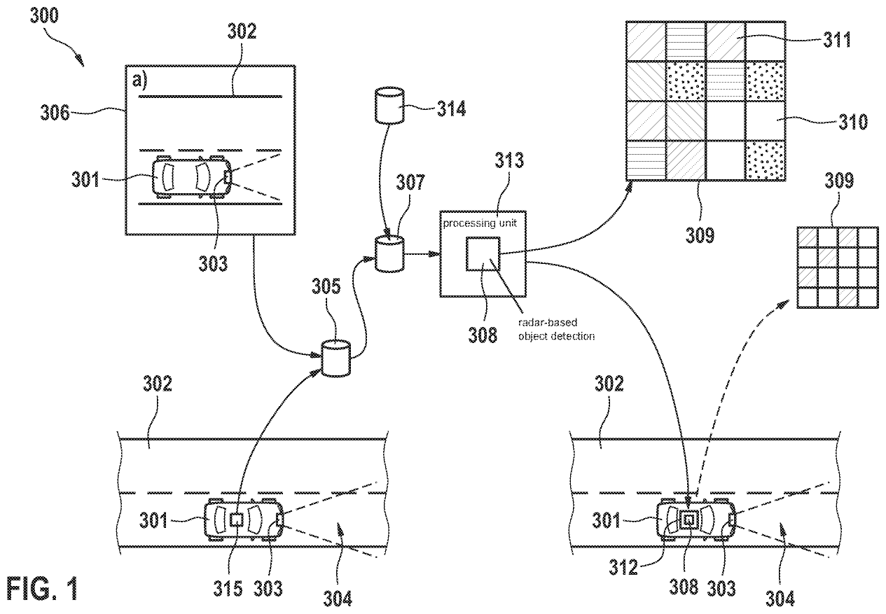

FIG. 1 schematically shows a representation of a system 300 for training a radar-based object detection 308 and for carrying out a radar-based surroundings detection.

In the specific embodiment shown, system 300 includes a processing unit 313. Processing unit 313 is configured to carry out method 100 according to the present invention for training a radar-based object detection 308. For this purpose, a corresponding radar-based object detection 308 is installed on processing unit 313 and is executable by processing unit 313.

Radar-based object detection 308 according to the present invention may be designed as an artificial intelligence, for example, as a neural network.

To train radar-based object detection 308, a training data set 307 is initially created based on radar data 305 of a radar sensor 303 or of a plurality of radar sensors 303. Radar data 305 in this case form surroundings 304 of the one or of the plurality of radar sensors 303.

Radar data 305 may, for example, include actual radar data, which are based on a plurality of radar measurements. Thus, to create radar data 305, a plurality of radar measurements of a plurality of radar sensors 307 may be carried out, with the aid of which surroundings 304 of respective radar sensors 303 are mapped.

In the specific embodiment shown, corresponding radar sensors 303 are designed as radar sensors 303 of at least one vehicle 301. Thus, to create radar data 305, a plurality of radar measurements of radar sensors 303 of vehicle 301 or, alternatively, of a plurality of different vehicles 301 may be carried out, and thus corresponding mappings of surroundings 304 of vehicles 301 are generated by radar data 305. For this purpose, corresponding vehicles 301 may carry out drives along arbitrary roadways 302 in order to thus record radar data 305 required for generating training data set 307.

Alternatively or in addition, radar data 305 of training data set 307 may be based on a simulation 306 of corresponding radar measurements of radar sensors 303. A corresponding simulation 306 is represented in FIG. 1 by graphic a, in which corresponding radar measurements are represented by radar sensors 303 of a plurality of vehicles 301.

According to one specific embodiment, corresponding sensor calibrations of radar sensors 303 simulated in simulation 306 may be taken into account in simulation 306 for generating simulated radar data 305. The sensor calibrations in this case may be taken into account in the form of correlations between point targets situated in surroundings 304 of radar sensors 303 and radar signals reflected thereon and corresponding time signals of radar sensors 303.

In simulations 306, interference disruptions of various radar signals of different radar sensors 303 may further be taken into account.

According to one specific embodiment, radar data 305, both those based on actual radar measurements as well as those based on corresponding simulations 306, are designed as raw data of FMCW radar sensors. Radar data 305 based on the raw data include in this case time signals of radar sensors 303, which are based on interferences between reference signals and received radar signals of the FMCW radar sensors.

According to one specific embodiment, radar data 305 may additionally or alternatively include frequency signals, which are based on a pre-processing of the raw data of the FMCW radar sensors via execution of a two-dimensional fast Fourier transform.

Training data set 307 may also include separate pieces of calibration information 314. Pieces of calibration information 314 relate in this case to the sensor calibration of radar sensors 303, both for radar data 305 of simulations 306 and for radar data 305 for the actual radar measurements. Pieces of calibration information 314 in this case may serve, in addition to radar data 305, as independent input data of radar-based object detection 308.

To train radar-based object detection 308 based on training data set 307, conventional training processes rom the related art in the form of supervised or unsupervised learning may be carried out.

According to the present invention, radar-based object detection 308 is trained in this case to generate an output representation of surroundings 304 of radar sensors 303 mapped by radar data 305 based on radar data 305 of training data set 307. In the specific embodiment shown, the output representation is designed as a reflectance grid 309. Reflectance grids 309 in this case are configured in such a way that each grid cell 310 of a reflectance grid 309 is assigned a reflectance value 311. Reflectance value 311 in this case describes a backscatter characteristic for radar signals of the spatial area of surroundings 304 represented in each case by grid cells 310. In FIG. 1, the different reflectance values 311 are represented by the different shadings of individual grid cells 310. In addition to reflectance values 311, grid cells 310 may also include information relating to relative speeds of dynamic objects, which move in the surroundings relative to respective radar sensor 303.

In the training of radar-based object detection 308, reflectance grids interpreted as ground truth may further be taken into consideration, which are known reflectance grids of radar data 305, and which represent surroundings 304 described by radar data 305 of training data set 307. The reflectance grids considered to be ground truth may be generated both on radar data 305 generated by the measurements as well as on radar data 305 based on simulations 306. The reflectance grids may be generated for this purpose via conventional signal processing from the related art, for example, based on radar data 305 of the radar measurements. Alternatively or in addition, the reflectance grids interpreted as ground truth may be simulated together with corresponding radar data 305 as part of simulations 306. The reflectance grids simulated or calculated by signal processing and interpreted as ground truth may be used in the training as a reference for the quality of reflectance grid 309 generated by radar-based object detection 308, for example, during a supervised learning process.

After successful training, correspondingly trained radar-based object detection 308 may be installed in a further processing unit 312 and executed by the latter for carrying out a radar-based surroundings detection.

In the specific embodiment shown, correspondingly trained radar-based object detection 308 is installed in a processing unit 312 of a vehicle 301 for carrying out a radar-based surroundings detection of surroundings 340 of vehicle 301.

To detect the surroundings, radar data 305 of the at least one radar sensor 303 of motor vehicle 301 are initially received, radar data 305 mapping surroundings 304 of radar sensor 303. Vehicle 301 preferably includes a plurality of radar sensors 303, so that in the course of the surroundings detection a position determination of detected objects within surroundings 304 is made possible via the plurality of radar sensors 303.

According to the present invention, radar sensors 303 may be designed as FMCW radar sensors.

To carry out the radar-based surroundings detection, radar-based object detection 303 trained according to method 100 according to the present invention is subsequently carried out on received radar data 305 of the plurality of radar sensors 303 of vehicle 301. Radar-based object detection 308 designed as artificial intelligence, in particular, as a neural network in this case may be applied according to the present invention directly to raw data of the FMCW radar sensors designed as time signals. Alternatively, a pre-processing of the raw data of the FMCW radar sensors may initially be carried out and a conversion of the time signals of the raw data into interference signals may be effectuated via execution of a two-dimensional fast Fourier transform.

By carrying out correspondingly trained radar-based object detection 308 on the time signals or interference signals of radar data 305 of radar sensors 303, an output representation of surroundings 304 of motor vehicle 301 mapped by radar data 305 of radar sensors 303 may be generated by radar-based object detection 308. In the specific embodiment shown, the output representation is designed as a reflectance grid 309. According to the present invention, individual grid cells 310 of reflectance grid 309 are provided in this case with reflectance values 311, which represent a backscatter characteristic for radar signals of a spatial area of surroundings 304 represented in each case by grid cell 310.

Thus, a presence of objects within surroundings 304 may be detected via calculated reflectance values 311. Via correspondingly generated reflectance grid 309, it is possible to achieve a detection of objects statically situated in surroundings 304 of vehicle 301. During the course of the surroundings detection, correspondingly generated reflectance grids 309 may be used for a further control of vehicle 301.

Alternatively to the specific embodiment shown, the output representation may also be designed as a point cloud of reflectance points or as a point cluster or as a plurality of point clusters of a radar road signal map display (radar road signature).

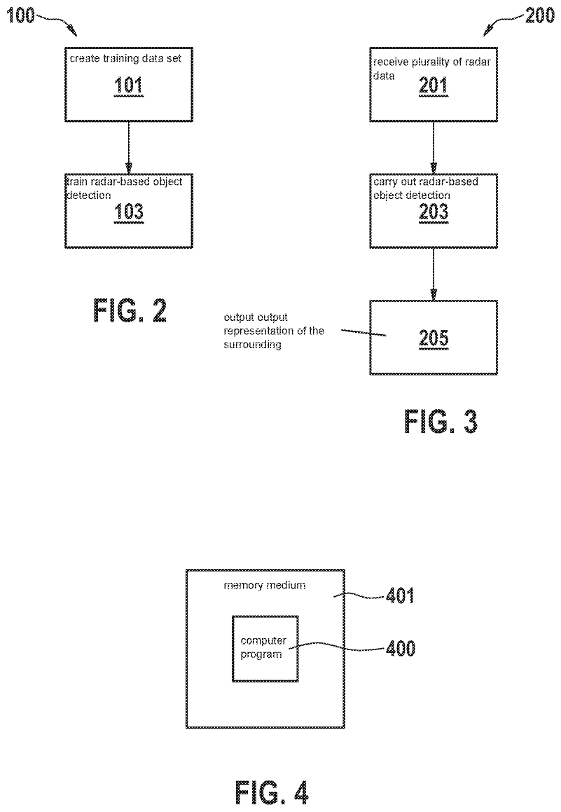

FIG. 2 shows a flowchart of method 100 for training a radar-based object detection 308.

According to the present invention, to train a radar-based object detection 308, a training data set 307 is initially created in a first method step 101, which includes radar data 305 of one or of multiple of radar sensors 303, which form a map of surroundings 304 or represent multiple radar sensors 303. Radar data 305 in this case may be based on actual radar measurements by the plurality of radar sensors 303. Alternatively or in addition, radar data 305 may be based on simulations 306 of corresponding radar measurements.

Radar data 305 in this case may also be designed as raw data of FMCW radar sensors and may include time signals. Alternatively, radar data 305 may be based on a pre-processing of the raw data of the FMCW radar sensors, in which a conversion of the time signals into frequency signals takes place via execution of a two-dimensional fast Fourier transform on the raw data.

Simulations 306 for generating simulated radar data 305 may further include sensor calibrations of radar sensors 303. Alternatively or in addition, simulations 306 may take interference disruptions of various radar signals of different radar sensors 303 into account.

Training data set 307 may further include pieces of calibration information 314 as independent data which, in addition to radar data 305, are used as input data of radar-based object detection 308.

Based on training data set 307, radar-based object detection 308 is trained in a further method step 103 for generating an output representation of the surroundings of radar sensor 303. The output representation may be designed as a point cloud of reflectance points of radar signals or as at least one point cluster of radar road signature map display or as a reflectance grid 309. Reflectance grid 309 in this case describes a grid-like representation of surroundings 304 of the plurality of radar sensors 303. Each grid cell 310 of reflectance grid 309 is provided in this case with a reflectance value 311, which describes a backscatter characteristic for radar signals of a spatial area of surroundings 304 represented by the respective grid cell 310. In addition, grid cells 310 may include pieces of information relating to relative speeds of objects moved dynamically relative to the radar sensor.

Radar-based object detection 308 may be designed as a neural network, in particular, as a neural network with a recurrent network structure. The neural network in this case may be configured to filter out influences of objects within surroundings 304 dynamically moved relative to radar sensors 303 from radar data 305.

In the training, occupancy grids considered to be ground truth may further be taken into account, which are based on radar data 305 of training data set 307, and of which it is known that they reliably represent surroundings 304 of the radar sensors mapped by the respective radar data 305 of training data set 307. The reflectance grids interpreted as ground truth may, for example, be simulated in simulations 306 or may be calculated with the aid of conventional signal processing methods from the related art. The reflectance grids interpreted as ground truth may be used in the training of radar-based object detection 308 as a reference for the quality of reflectance grids 309 generated by radar-based object detection 308 based on radar data 305 of training data set 307.

FIG. 3 shows a flowchart of method 200 for radar-based surroundings detection.

According to the present invention, for radar-based surroundings detection, a plurality of radar data 305 of one or of a plurality of radar sensors 303 is initially received in a first method step 201, radar data 305 mapping surroundings 304 of radar sensor 303 or of the plurality of radar sensors 303. Radar data 305 in this case may be radar data of one or of a plurality of FMCW radar sensors. Radar data 305 may be, in particular, raw data of FMCW radar sensors and may be designed as time signals. Alternatively, radar data 305 may be generated by a pre-processing of the raw data of radar sensors 303 via execution of a two-dimensional fast Fourier transform and may be designed as frequency signals. Radar data 305 may, in particular, be sensor data of radar sensors 303 of a vehicle 301 and may map surroundings 304 of vehicle 301.

In one further method step 203, a radar-based object detection 308 is carried out on received radar data 305. Radar-based object detection 308 in this case is trained according to method 100 according to the present invention for training a radar-based object detection 308.

In one further method step 205, an output representation of the surroundings of the radar sensor or of the vehicle is output by radar-based object detection 308. The output representation in this case may be designed as a point cloud of reflectance points of radar signals or as a point cluster or as a plurality of point clusters of a radar road signature map display or as a reflectance grid 309. A reflectance grid 309 in this case represents a grid-like representation of surroundings 304, each grid cell 310 of reflectance grid 309 being provided with a reflectance value 311, which describes a backscatter characteristic for radar signals of the spatial area of surroundings 304 represented in each case by grid cell 310.

FIG. 4 schematically shows a representation of a computer program product 400, including commands which, when the program is executed by a processing unit, prompt the program to carry out method 100 for training a radar-based object detection and/or method 200 for the radar-based surroundings detection.

Computer program 400 in the specific embodiment shown is stored on a memory medium 401. Memory medium 401 in this case may be an arbitrary conventional memory medium from the related art.

What is claimed is:

1. A method for training a radar-based object detection, comprising the following steps:
creating a training data set that includes radar data of a radar sensor or of a plurality of radar sensors, the radar data representing a map of surroundings of the radar sensor or of the plurality of radar sensors; and
training the radar-based object detection based on the created training data set for generating an output representation of the surroundings of the radar sensor or of the plurality of radar sensors, the output representation being configured as a point cloud of reflectance points of radar signals or as a point cluster or as a plurality of point clusters of a radar road signature map display or as a reflectance grid, the reflectance grid describing a grid-like representation of the surroundings of the radar sensor or of the plurality of radar sensors, and each grid cell of the reflectance grid being provided with a reflectance value, using which a backscatter characteristic of radar signals of a respective spatial area of the surroundings is described.

2. The method as recited in claim 1, wherein the radar data are raw data of FMCW radar sensors and are time signals.

3. The method as recited in claim 2, wherein the radar data are based on an execution of a two-dimensional fast Fourier transform on the raw data and are frequency signals.

4. The method as recited in claim 1, wherein the radar data include data based on measurements of the radar sensor or of the plurality of radar sensors and/or on simulations of radar measurements.

5. The method as recited in claim 4, wherein sensor calibrations of the radar sensor or the plurality of radar sensors in the form of correlations between radar signals reflected at point targets situated in the surroundings and corresponding time signals of the radar sensor or the plurality of radar sensors are taken into account in the simulations.

6. The method as recited in claim 4, wherein interference disruptions of various radar signals are taken into account in the simulations.

7. The method as recited in claim 1, wherein the training data set further includes pieces of calibration information relating to the sensor calibration of the radar sensor or the plurality of radar sensors, and the pieces of calibration information are utilized as input data of the radar-based object detection.

8. The method as recited in claim 1, wherein the radar-based object detection is a neural network.

9. The method as recited in claim 8, wherein the neural network is a recurrent network structure and is trained to filter out a filtering of influences of objects dynamically moved relative to the radar sensor or to the plurality of radar sensors.

10. A method for radar-based surroundings detection, comprising the following steps:
receiving radar data of a radar sensor or of a plurality of radar sensors, the radar data mapping surroundings of the radar sensor or of the plurality of radar sensors;
carrying out an object detection on the received radar data, the object detection being trained by:
creating a training data set that includes first radar data of the radar sensor or of the plurality of radar sensors, the first radar data representing a map of surroundings of the radar sensor or of the plurality of radar sensors, and
training the object detection based on the created training data set for generating an output representation of the surroundings of the radar sensor or of the plurality of radar sensors, the output representation being configured as a point cloud of reflectance points of radar signals or as a point cluster or as a plurality of point clusters of a radar road signature map display or as a reflectance grid, the reflectance grid describing a grid-like representation of the surroundings of the radar sensor or of the plurality of radar sensors, and each grid cell of the reflectance grid being provided with a reflectance value, using which a backscatter characteristic of radar signals of a respective spatial area of the surroundings is described; and
outputting a first output representation of the surroundings of the radar sensors by the object detection, the first output representation being configured as the point cloud of reflectance points of radar signals or as the point cluster or as the plurality of point clusters of a radar road signature map display or as the reflectance grid.

11. The method as recited in claim 10, wherein the radar data are radar data of radar sensors of a vehicle, and surroundings of the vehicle being mapped by the radar data.

12. The method as recited in claim 10, wherein the radar data are raw data of an FMCW radar sensor and are time signals.

13. The method as recited in claim 12, wherein the radar data are based on an execution of a two-dimensional fast Fourier transform on the raw data and are frequency signals.

14. A processing unit configured to train a radar-based object detection, the processing unit configured to:
create a training data set that includes radar data of a radar sensor or of a plurality of radar sensors, the radar data representing a map of surroundings of the radar sensor or of the plurality of radar sensors;
train the radar-based object detection based on the created training data set for generating an output representation of the surroundings of the radar sensor or of the plurality of radar sensors, the output representation being configured as a point cloud of reflectance points of radar signals or as a point cluster or as a plurality of point clusters of a radar road signature map display or as a reflectance grid, the reflectance grid describing a grid-like representation of the surroundings of the radar sensor or of the plurality of radar sensors, and each grid cell of the reflectance grid being provided with a reflectance value, using which a backscatter characteristic of radar signals of a respective spatial area of the surroundings is described.

15. A non-transitory computer readable medium on which is stored a computer program including commands for training a radar-based object detection, the commands, when executed by a data processing unit, causing the data processing unit to perform the following steps:
creating a training data set that includes radar data of a radar sensor or of a plurality of radar sensors, the radar data representing a map of surroundings of the radar sensor or of the plurality of radar sensors; and
training a radar-based object detection based on the created training data set for generating an output representation of the surroundings of the radar sensor or of the plurality of radar sensors, the output representation being configured as a point cloud of reflectance points of radar signals or as a point cluster or as a plurality of point clusters of a radar road signature map display or as a reflectance grid, the reflectance grid describing a grid-like representation of the surroundings of the radar sensor or of the plurality of radar sensors, and each grid cell of the reflectance grid being provided with a reflectance value, using which a backscatter characteristic of radar signals of a respective spatial area of the surroundings is described.
